(19) United States
(12) Patent Application Publication
(10) Pub. No.: US 2016/0243591 A1
(43) Pub. Date: Aug. 25, 2016

(54) RADIATION MEASURING AND SORTING DEVICE AND RADIATION MEASURING AND SORTING METHOD

(71) Applicant: ISO-Pacific Nuclear Assay Systems, Inc., Richland, WA (US)

(72) Inventors: Toshimitsu KAMADA, Osaka (JP); Tetsunori FUNAKOSHI, Osaka (JP); Norio YAMAKAWA, Osaka (JP); Kazuki MIURA, Osaka (JP); Michael John Dillon, Richland, WA (US)

(21) Appl. No.: 14/974,927

(22) Filed: Dec. 18, 2015

Related U.S. Application Data
(63) Continuation of application No. PCT/JP2014/066249, filed on Jun. 19, 2014.

(30) Foreign Application Priority Data
Jun. 20, 2013 (JP) 2013-129838

(51) Int. Cl. B07C 5/346; G01T 1/167

(52) U.S. Cl. CPC B07C 5/346; G01T 1/167

(57) ABSTRACT

Providing a transporting mechanism 2 for transporting an introduced target object 100 in a fixed transportation direction F1, a measuring device 40 for measuring the radiation of the target object 100 being transported by the transporting mechanism 2, a sorting mechanism 3 for sorting the target object 100 disposed at a downstream end of the transporting mechanism 2 based on the measurement result of the measuring device 40, and a control unit 5 for controlling the operation of a transporting belt 20 of the transporting mechanism 2 and a sorting belt 30 of the sorting mechanism 3. The sorting mechanism 3 is disposed so that an operating direction F2 of the sorting belt 30 intersects an operating direction F1 of the transporting belt 20 and is capable of forward and reverse rotation. When the measurement result changes, the control unit 5 stops the transporting belt 20 after a specific time period has passed, discharges the target object 100 on the sorting belt 30 to the outside, releases the stopping of the transporting belt 20, and causes the sorting belt 30 to rotate in reverse.

### BACKGROUND

1. Technical Field

The present invention relates to a radiation measuring and sorting device and to a radiation measuring and sorting method. Additionally, in greater detail, the present invention relates to a sorting device and a sorting method that provide a transporting mechanism for transporting an introduced target object in a fixed transportation direction, a measuring device for measuring the radiation of the target object being transported by the transporting mechanism, a sorting mechanism for sorting the target object disposed at a downstream end of the transporting mechanism based on the measurement result of the measuring device, and a control unit for controlling the operation of a transporting belt of the transporting mechanism and a sorting belt of the sorting mechanism.

2. Background

Conventionally, a conveyor type sorting device, like, for example, that described in Non-patent Document 1, is known as a radiation measuring and sorting device like that described above. However, sorting performance based on levels of radioactivity is inadequate.

### DOCUMENTS OF THE RELATED ART

### Non-Patent Documents

ISO Pacific Nuclear Assay Systems, “S3 System Technical Document (ISO PACIFIC TECHNICAL,” (US), 2009

### SUMMARY

### Problem to be Solved by the Invention

In view of the conventional conditions, an object of the present invention is to provide a radiation measuring and sorting device and a radiation measuring and sorting method having high sorting performance.

### Means for Solving the Problem

In order to achieve the object described above, the radiation measuring and sorting device according to the present invention is characterized by a configuration providing a transporting mechanism for transporting an introduced target object in a fixed transportation direction, a measuring device for measuring the radiation of the target object being transported by the transporting mechanism, a sorting mechanism for sorting the target object disposed at a downstream end of the transporting mechanism based on the measurement result of the measuring device, and a control unit for controlling the operation of a transporting belt of the transporting mechanism and a sorting belt of the sorting mechanism, where the sorting mechanism is disposed so that an operating direction of the sorting belt intersects an operating direction of the transporting belt and is capable of forward and reverse rotation, and, when the measurement result changes, the control unit stops the transporting belt after a specific time period has passed, discharges the target object on the sorting belt to the outside, releases the stopping of the transporting belt, and causes the sorting belt to rotate in reverse.

According to the configuration described above, the sorting mechanism is disposed so that the operating direction of the sorting belt thereof intersects the operating direction of the transporting belt, and thus not only does the target object transported by the transporting belt drop onto the sorting belt, the device configuration is simple. Furthermore, the sorting belt is capable of forward and reverse rotation, and thus the target object is efficiently sorted in the operating direction of the sorting belt by a simple control. Moreover, when the measurement result changes, the control unit stops the transporting belt after a specific time period has passed, discharges the target object on the sorting belt to the outside, releases the stopping of the transporting belt, and causes the sorting belt to rotate in reverse. By this, a target object that has passed the measuring device is made to wait just before moving to the sorting belt, and, during this time, a target object on the sorting belt can be discharged so that a target object with a different measurement result does not become mixed onto the sorting belt. Additionally, after the target object on the sorting belt has been discharged, the stopping of the transporting belt is released and the sorting belt is rotated in reverse, and thus the target object can be separated (sorted) based on the measurement result. In this way, because sorting accuracy is extremely high and is activated when the measurement result changes, sorting efficiency is also good.

When the measurement result exceeds a reference value, it is advisable that the control unit stop the transporting belt at a time that is a first stopping time before an arrival time at which a portion of the target object corresponding to the measurement result will arrive at the downstream end of the transporting belt. Because the transporting belt is stopped at the time of the first stopping time before the arrival time, even if there is a portion where the measurement value is high locally, that portion can be prevented from being moved to the sorting belt, thus improving sorting accuracy. Furthermore, using the small amount of time before a motor, and the like, of the transporting belt completely stops, a portion of a target object that exceeds the reference value is not mixed onto the sorting belt with a portion of the target object that falls below the reference value.

Additionally, when the measurement result falls below the reference value, it is advisable that the control unit stop the transporting belt at a time that is a second stopping time after an arrival time at which a portion of the target object corresponding to the measurement result will arrive at the downstream end of the transporting belt. Because the transporting belt is stopped at the time of the second stopping time after the arrival time, even if there is a portion where the measurement value is high locally, that portion can be prevented from being moved to the sorting belt, thus improving sorting accuracy. Furthermore, using the small amount of time before a motor, and the like, of the transporting belt completely stops, a portion of a target object that falls below the reference value is not mixed onto the sorting belt with a portion of the target object that exceeds the reference value.

In this case, it is preferable that the first stopping time be at least equal to a measurement unit of time of the measuring device, and that the second stopping time is longer than the first stopping time. By making the first stopping time at least equal to the measurement unit of time of the measuring device, the mixing of target objects having different results based on measurement timing can be prevented. Furthermore, because when the measurement result falls below the reference value it means that the value just before had exceeded the reference value, by setting the second stopping time longer than a stopping time that is at least equal to the measurement time, a portion of a target object, particularly a portion that exceeds a determining standard, can be reliably separated (sorted).

It is advisable that the measuring device have a collimator for limiting a field of vision of the measuring device, which is based on the height of the transporting belt, which limits an energy window of the measuring device to match a specific radio nuclide in the target object. The effect of the radiation in the vicinity of the measuring device can be eliminated by the collimator, thus enhancing measuring accuracy. However, by matching the energy window to a specific radio nuclide, the effect of the energy and background data of other radio nuclides can be minimized, thus enhancing measuring accuracy and enhancing sorting accuracy.

In this case, it is advisable that a shielding body for blocking external radiation below the transporting belt be provided in the field of vision. By this, radiation from the ground is blocked and measuring accuracy is enhanced further. Additionally, it is advisable that a second shielding body, for blocking external radiation, be provided above the collimator. By this, the effect of radiation from above the measuring device can be eliminated, making it possible to enhance accuracy even more.

It is advisable that the radiation measuring and sorting device have a hopper for introducing the target object upstream of the measuring device where adjusting means for adjusting the thickness of the target object is provided on the hopper side between the hopper and the measuring device. By this, forming the thickness of the target object substantially uniformly and the surface thereof substantially flat, and then passing (transporting) the target object under the measuring device, can suppress variations in measurement results caused by the thickness and shape of the target object, which can enhance accuracy.

The target object is, for example, a radioactively contaminated object containing at least soil, a waste product, incineration ash, fly ash, or vegetation.

In order to achieve the object described above, the radiation measuring and sorting method according to the present invention is characterized by a method for transporting an introduced target object using a transporting mechanism in a fixed transportation direction, measuring the radiation of the target object being transported by the transporting mechanism, and sorting the target object disposed downstream of the transporting mechanism based on the measurement result of the measuring device, where the sorting mechanism is disposed so that an operating direction of a sorting belt of the sorting mechanism intersects an operating direction of a transporting belt of the transporting mechanism and is capable of forward and reverse rotation, and, when the measurement result changes, the transporting belt is stopped after a specific time period has passed, the target object on the sorting belt is discharged to the outside, the stopping of the transporting belt is released, and the sorting belt is caused to rotate in reverse.

When the measurement result exceeds a reference value, it is advisable that the transporting belt be stopped at a time that is a first stopping time before an arrival time at which a portion of the target object corresponding to the measurement result will arrive at the downstream end of the transporting belt. Additionally, when the measurement result falls below a reference value, it is advisable that the transporting belt be stopped at a time that is a second stopping time after an arrival time at which a portion of the target object corresponding to the measurement result will arrive at the downstream end of the transporting belt. In this case, it is preferable that the first stopping time be at least equal to the measurement unit of time of the measuring device, and that the second stopping time is longer than the first stopping time.

### Effect of the Invention

Use of the sorting device and the sorting method according to the present invention leads to enhanced sorting performance compared to conventional devices and methods.

Another object of the present invention, with regard to configuration and effect, will become obvious from the matters of the following description of the preferred embodiments.

### BRIEF DESCRIPTION OF THE DRAWINGS

FIG. 1 is a plan view of the radiation measuring and sorting device according to the present invention.

FIG. 2 is a side view of the radiation measuring and sorting device.

FIG. 3 is a front view of the radiation measuring and sorting device.

FIG. 4 is a cross sectional view of a sorting mechanism.

FIG. 5 is a plan view of a transporting mechanism upstream from a measuring apparatus.

FIG. 6 is a cross sectional view of the transporting mechanism upstream from the measuring apparatus.

FIG. 7a is a cross sectional view along A-A (a transverse cross sectional view of an introduction hopper) of FIG. 5.

FIG. 7b is a cross sectional view along B-B (a longitudinal cross sectional view of the introduction hopper) of FIG. 5.

FIG. 8a is a plan view of a height adjusting device.

FIG. 8b is a cross sectional view along C-C (a side view of the height adjusting device).

FIG. 9a is a cross sectional view along D-D (a transverse cross sectional view of the measuring apparatus).

FIG. 9b is a cross sectional view along E-E (a longitudinal cross sectional view of the measuring apparatus).

FIG. 10 is the energy spectrum of a ¹³⁷Cs radiation source.

FIG. 11 is a drawing schematically illustrating the display contents of a monitor of a control device.

FIG. 12 is a diagram for describing the relationship between a column and a measurement range.

FIG. 13 is a diagram for describing the control of a main belt and a sorting belt, where (a) illustrates a measurement result, (b) illustrates a drive state of the main belt, and (c) illustrates a drive state of the sorting belt.

### DETAILED DESCRIPTION

Next, the present invention will be described in greater detail while making reference to the appropriate attached drawings. A radiation measuring and sorting device 1 according to the present invention was developed to sort large quantities of radioactively contaminated objects by the radiation levels thereof based on a wide range of radioactive contamination. A radioactively contaminated object that is to be a target object 100 is, for example, soil, a waste product, incineration ash, fly ash, vegetation, and the like. For example, the state of the target object 100 may be either hard like stone, clay like, sand like, dry, or wet. The sorting device 1 is able to remove a portion that is highly radioactively contaminated from the target object 100, and thus it is possible to reduce a radioactive air dose rate at a given location.

For example, the radiation measuring and sorting device 1 can be mounted on a large trailer, and the like, and transported to a location where the radioactive air dose rate is high due to radioactive contamination such as the site of a nuclear testing facility, the site of a nuclear power plant, or the like, and the radiation measuring and sorting device 1 can be activated at that location to reduce the radioactive air dose rate at that location by removing a highly radioactively contaminated portion from the target object 100. The radiation measuring and sorting device 1 is configured to continuously measure the radioactivity of the target object 100 and to implement sorting based on the radioactivity level of the target object 100 in a continuous fashion. Therefore, if a width W of a main belt 20 for transporting is made wide, it becomes possible to process, for example, approximately 200 m³ each hour.

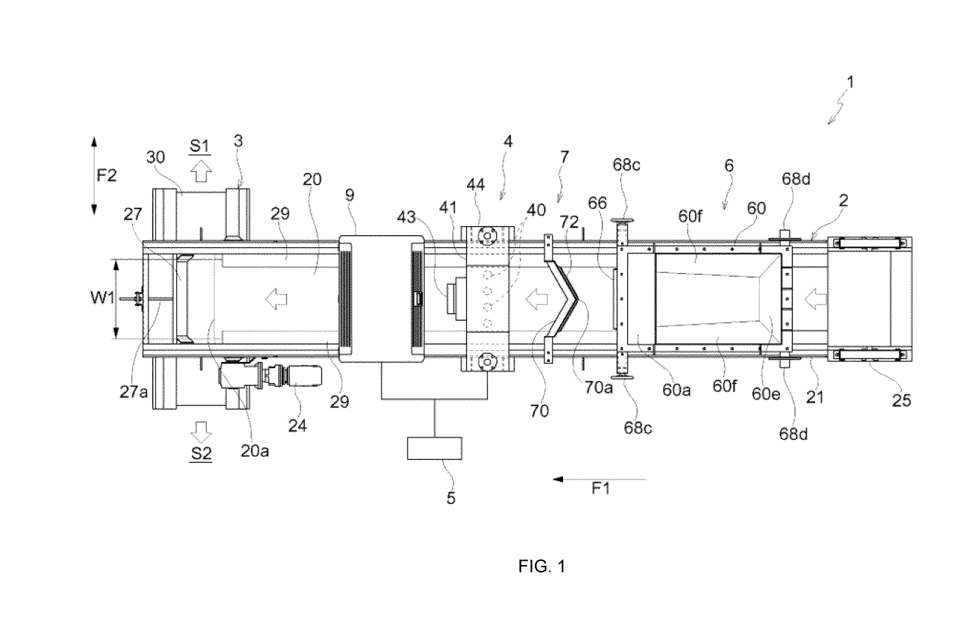

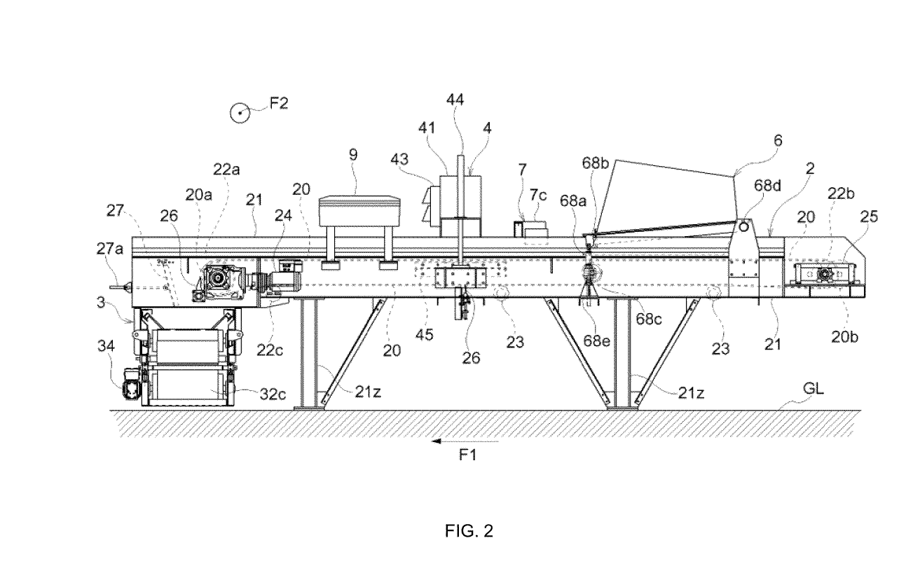

As illustrated in FIGS. 1 and 2, in outline, the radiation measuring and sorting device 1 has a transporting mechanism 2 that includes a main belt 20 as a transporting belt for transporting the target object 100 in a fixed transportation direction F1, a measuring apparatus 4 that includes a measuring device (gauging device) 40 for measuring (gauging) the radiation of the target object 100 being transported by the main belt 20, and a sorting mechanism 3 that includes a sorting belt 30 for sorting the target object 100, which has been disposed at the downstream end 20a of the main belt 20 and measured for radiation, based on a measurement result of the measuring device 40. An introduction hopper 6, a height adjusting device 7, the measuring apparatus 4, and a power supply device 9 are disposed in the transporting mechanism 2, in that order in the transportation direction F1, which is the operating direction of the main belt 20, from an upstream end 20b to the downstream end 20a of the main belt 20. A control device 5, configured from a computer for example, is connected to the measuring apparatus 4 and the power supply device 9.

As illustrated in FIGS. 1 and 2, the main belt 20 passes the target object 100 introduced from the introduction hopper 6 directly under the measuring apparatus 4, and then transports the object to the sorting mechanism 3. The main belt 20 is stretched between a drive pulley 22a and a tail pulley 22b by a snap pulley 22c and a return roller 23 within a chassis 21. The distance between the drive pulley 22a and the tail pulley 22b is set at, for example, about 6 m. The drive pulley 22a is provided on the downstream end 20a side, and an inverter motor 24 is connected thereto. The inverter motor 24 drives the main belt 20 at a fixed rotating speed and at a fixed transporting speed in the transportation direction F1 only. The transporting speed is set at, for example, 7.5 cm to 20 cm per second, based on the state and measuring accuracy of the target object 100. The tail pulley 22b is provided on the upstream end 20b side, and is provided with a meander prevention mechanism 25 for keeping the main belt 20 from meandering. By these, the target object 100, which has been molded into a fixed shape by the introduction hopper 6, is transported along the transportation direction F1 at a fixed speed without destroying the molded shape. Accordingly, reductions in radiation measuring accuracy can be suppressed.

Furthermore, a multistage scraper 26 is provided on the outside of the drive pulley 22a and under the measuring apparatus 4. The scraper 26 is made of either metal or synthetic resin and has a plate like shape. The scraper 26 presses against the surface of the main belt 20 to remove the target object 100 stuck to the main belt 20. A baffle plate 27 for dropping the transported target object 100 onto the center of the sorting belt 30 is provided on the downstream end 20a side of the main belt 20 through an angle adjustable attaching member 27a. Furthermore, the transporting portion of the main belt 20 is disposed on a plate like member 28, which provides a backup member 28a made of resin on an edge thereof. Additionally, a skirt 29 is provided on an edge of the main belt 20 along the transportation direction F1. Note that a width W1 of the main belt 20 can be adjusted suitably based on the number of measuring devices 40.

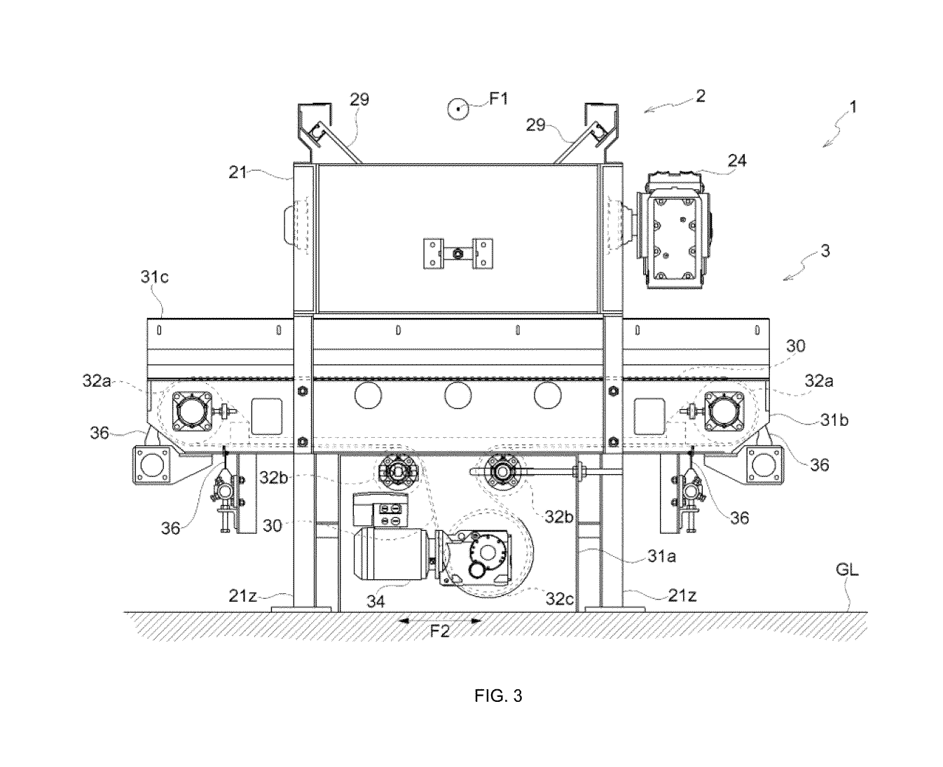

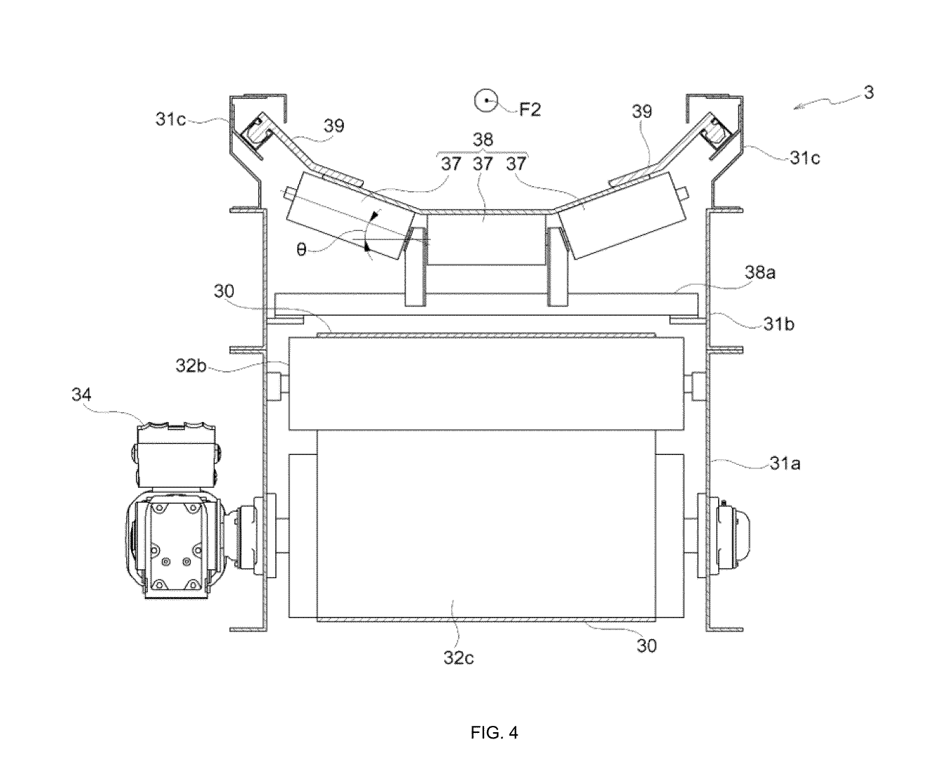

As illustrated in FIGS. 1 and 2, the sorting mechanism 3 is disposed to intersect the transporting mechanism 2 directly below the downstream end 20a of the main belt 20. In the present embodiment, an operating direction F2 of the sorting belt 30 is orthogonally aligned with the transportation direction (operating direction) F1 of the main belt 20. As illustrated in FIGS. 3 and 4, the sorting belt 30 is stretched between a pair of pulleys 32a and 32a within a chassis 31 through a pair of snap pulleys 32b and 32b and a drive pulley 32c. The distance between the pairs of pulleys 32a and 32b is set at, for example, about 1.8 m. The drive pulley 32c is connected to the inverter motor 34 and is capable of forward and reverse rotation. By this, the sorting belt 30 is able to switch a driving (advancing) direction based on the measurement result of the measuring apparatus 4, and thus distribute the target object 100 to sorting area S1 or S2. In the present embodiment, the sorting area S1 is set as a HOT side (abnormal), and the sorting area S2 is set as a CLEAN side (normal). The speed of the sorting belt 30 is, for example, about five times the speed of the main belt 20.

Furthermore, a scraper 36, that is the same as the previous scraper 26, is provided outside and in the vicinities of the lower portions of a pair of rollers 32a and 32a. The scraper 36 prevents the target object 100 from sticking to, or the target object 100 having a different measurement result from being introduced to, the surface of the sorting belt 30.

As illustrated in FIG. 4, a carrier roller 38 made up of three trough rollers 37 is secured in a middle level 31b of the chassis 31 through a securing member 38a. The carrier roller 38 is in a vicinity just below the downstream end 20a of the main belt 20, and the sorting belt 30 is thus maintained in the shape of a trough. By this, the target object 100 dropped from the main belt 20 is received and a transport volume is ensured. The trough angle θ of the trough roller 37 can be adjusted as appropriate, and is set at, for example, 20°. Furthermore, an inclined skirt 39 is provided along the operating direction F2 in an upper level 31c of the chassis 31.

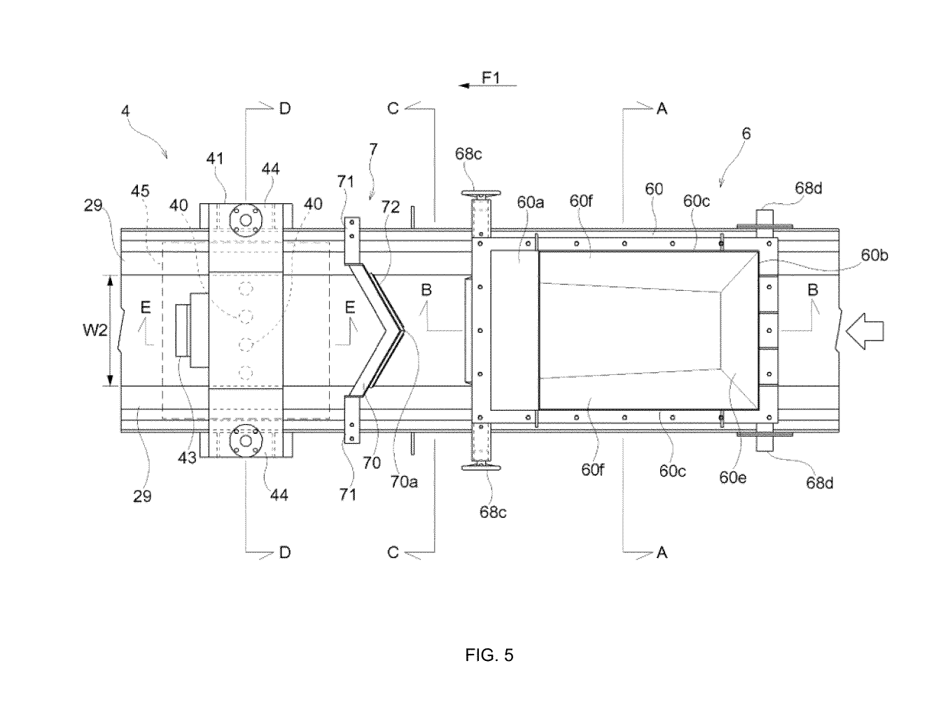

As illustrated in FIG. 5 through 7, the introduction hopper 6 discharges the target object 100 introduced to an introduction port 61 onto the main belt 20. The introduction port 61 is formed by an upper front wall 60a, an upper rear wall 60b, and an upper side wall 60c. The transportation direction F1 length of the introduction port 61 is shorter than the length of a height direction middle part 62 of a main body part 60 interior formed by the tilted upper front wall 60a. Each upper wall 60a through c and each lower wall 60d through f is linked and secured to the middle part 62. A lower part rear wall 60e is tilted toward the upstream side in the transportation direction F1. A lower side wall 60f is tilted toward the middle (center of the main belt 20) of the main body part 60. Through the shape of this type of main body part 60, the introduced target object 100 will move toward the forward middle part of the main body part 60 without becoming stuck in place on the wall surfaces 60a through f Furthermore, the target object 100 is discharged so as to be narrowed down toward the main belt 20.

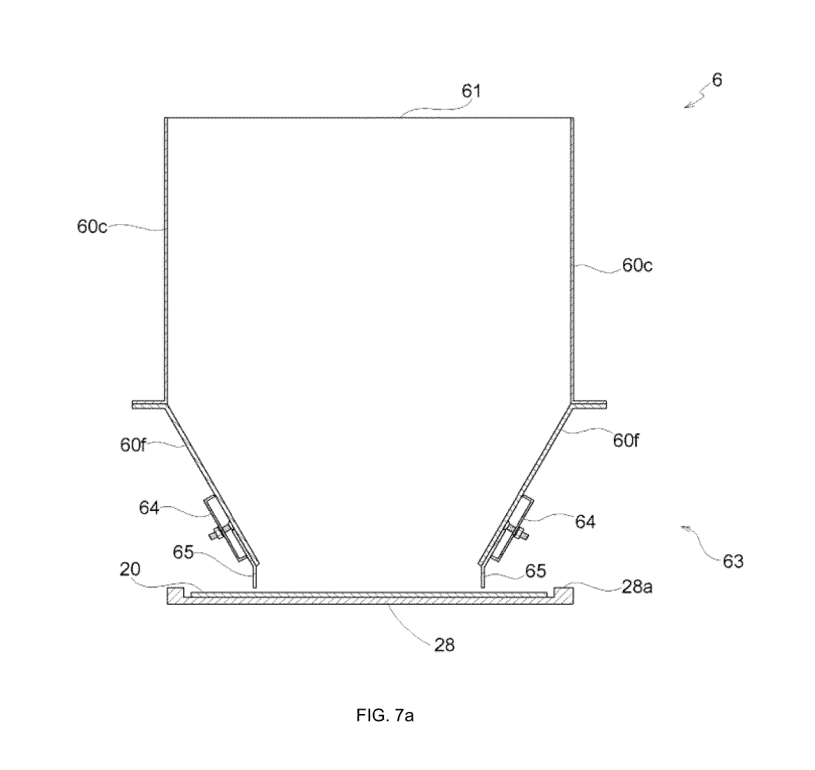

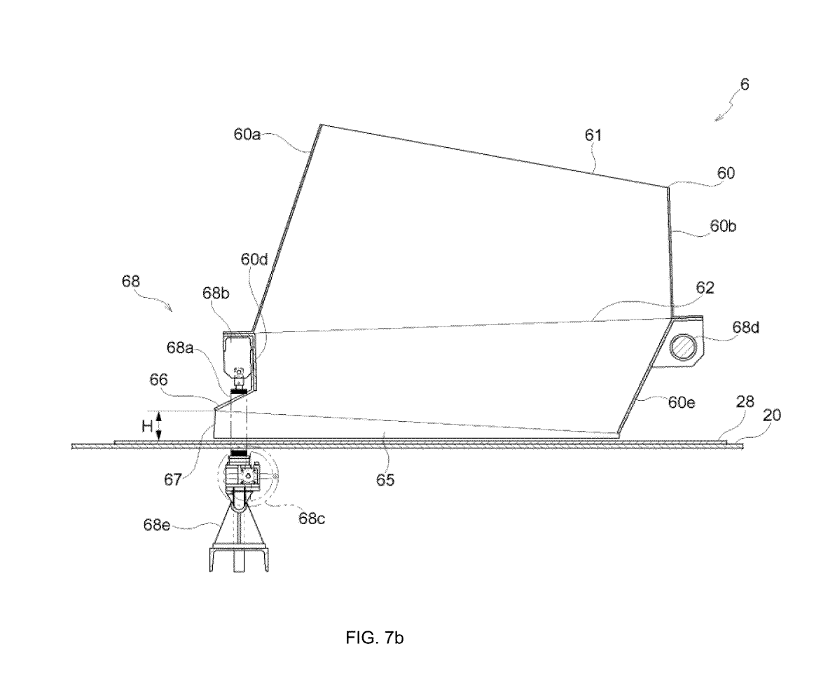

As illustrated in FIGS. 7a and 7b, a skirt 65 is attached to the bottom end part of the lower side wall 60f through a fixture 64. Furthermore, an inclined plate 66 is attached to the bottom end part of the lower front wall 60d. The skirt 65 and the inclined plate 66 form a discharge port 67 on the bottom part 63 of the main body part 60. The discharge port 67 demonstrates a function for forming the target object 100 into a fixed shape and then feeding the object onto the main belt 20, and thus performs the roll of a buffer for feeding the target object 100 to the main belt 20 in a continuous fashion.

The height H of the discharge port 67 can be adjusted by a height adjusting mechanism 68, as illustrated in FIG. 7b. The height adjusting mechanism 68 is made up of a jack 68a for moving a contacting part 68b, which abuts the main body 60, up and down, an operating handle 68c for operating the jack 68a, a mounting shaft 68d attached to the lower rear wall 60e, and a fixed base 68e that is fixed to the chassis 21. By raising and lowering, with the mounting shaft 68d as a height adjusting fulcrum and the contacting part 68b as a height adjusting leverage point 4b, the height H of the discharge port 67 can be adjusted to any height. In this way, the processed volume (inspected volume) per unit of time for radiation sorting varies based on the width W1 and transporting speed of the main belt 20, and the height of the discharge port 67. That is, by adjusting these, the processed volume can be adjusted.

As has been described above, the target object 100 introduced through the introduction hopper 6 is molded into a substantially trapezoidal shape and then discharged by the walls 60a through f and the discharge port 67 of the main body part 60. However, when the target object 100 is, for example, a highly viscous soil, the object can be pulled by the discharge port 67 and thus become higher than a set height H. Thus, a height adjusting device 7 for making the height of the target object 100 uniform is disposed on the downstream side of the discharge port 67.

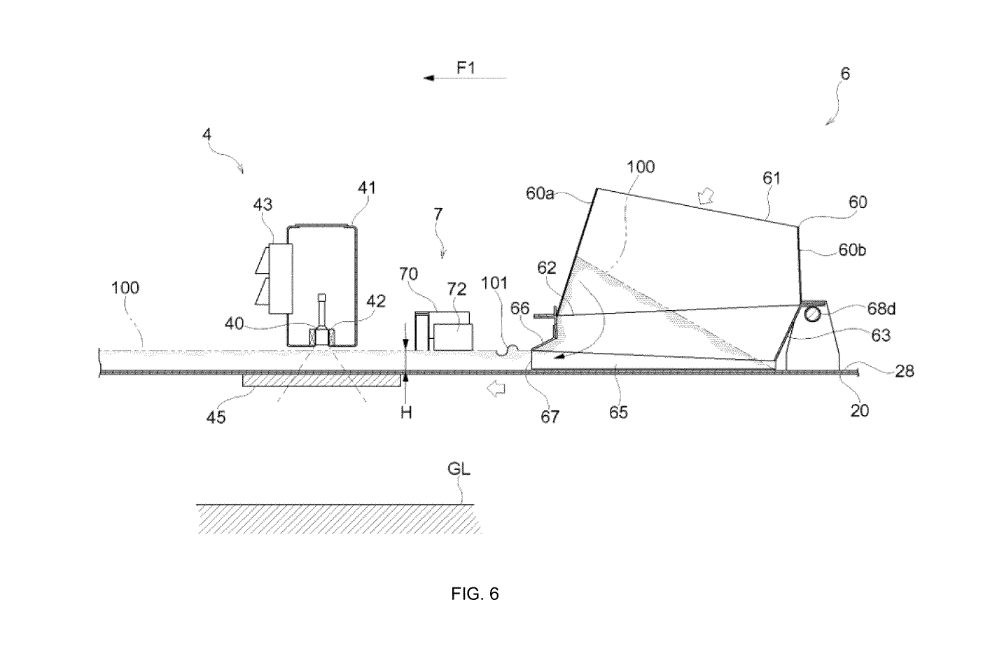

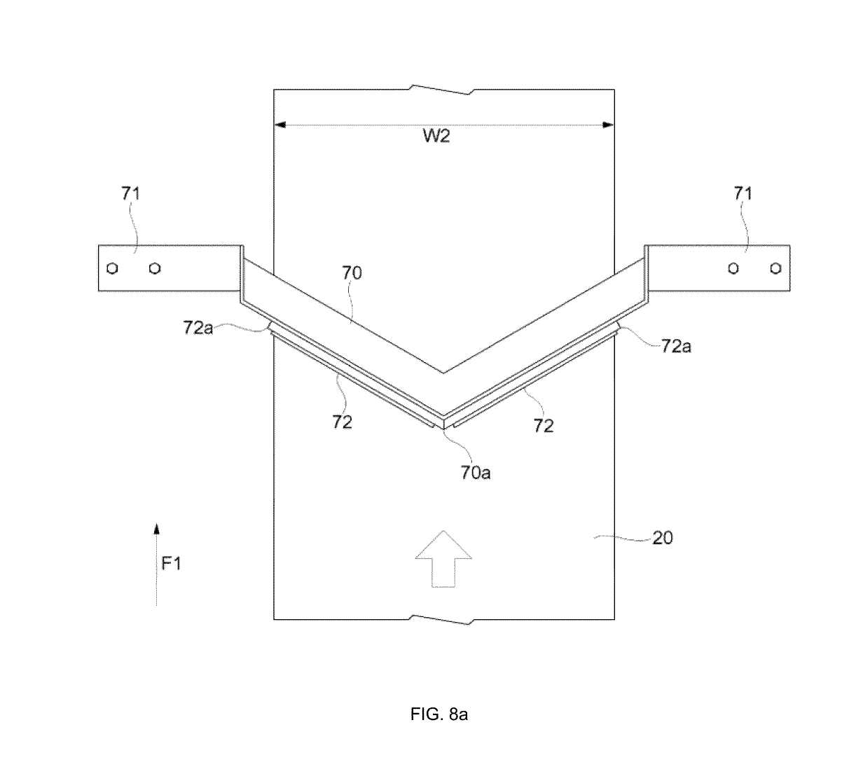

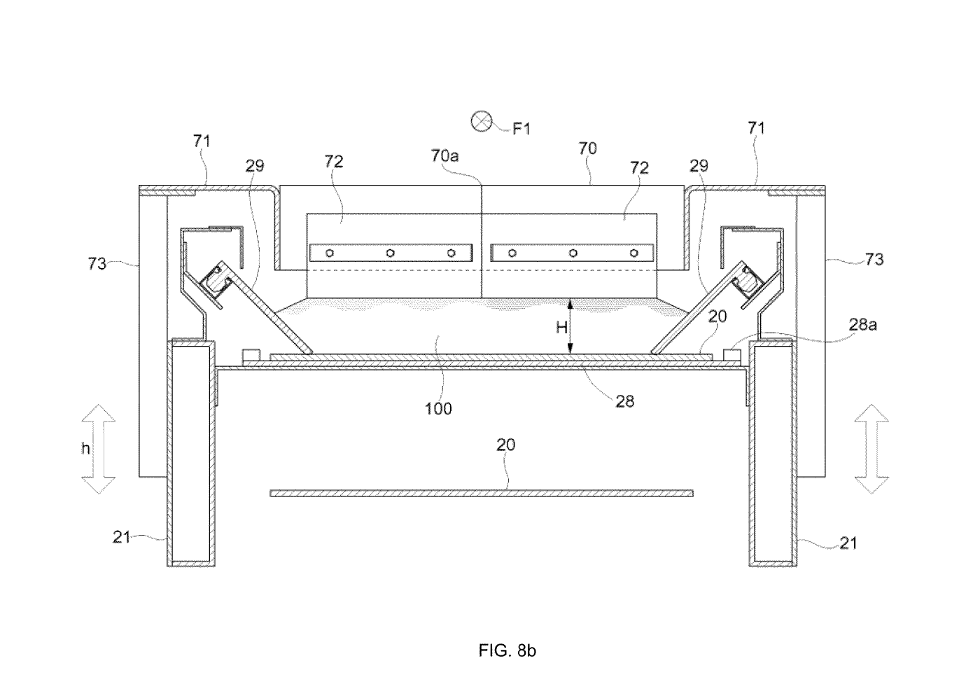

As illustrated in FIGS. 8a and b, the height adjusting device 7 has an adjusting bar 70, which is substantially V shaped when seen in a planar view, a plate like scraper 72 attached to the adjusting bar 70, and a height adjusting part 73 for adjusting the height of the adjusting bar 70 in a vertical direction h. The adjusting bar 70 is secured by an end part thereof to the chassis 21 through a securing part 71 and the height adjusting part 73, and an apex part 70a is disposed facing the upstream side. An uneven part 101 formed on a top surface 100a of the target object 100 is removed and made smooth, as illustrated in FIG. 6, by the shape (substantially triangular) and disposition of such an adjusting bar 70. By smoothing the top surface 100a, which is to be an inspection surface, measurement variations caused by surface shape can be suppressed, and thus reductions in accuracy can be prevented.

The scraper plate 72 is secured to a front surface on the upstream side of the adjusting bar 70. By this, a foreign object that is higher than a specific height H that gets mixed in with the target object 100 is moved from the apex part 70a toward an end part 72a. Therefore, the foreign object is prevented from colliding with the measuring apparatus 4 positioned downstream. Furthermore, because the apex part 70a of the adjusting bar 70 is aligned with the center of the main belt 20, substantially equal tension is applied to both edges of the main belt 20 such that belt meander is also prevented. Note that any foreign object caught in the end part 72a is recovered as appropriate by a worker.

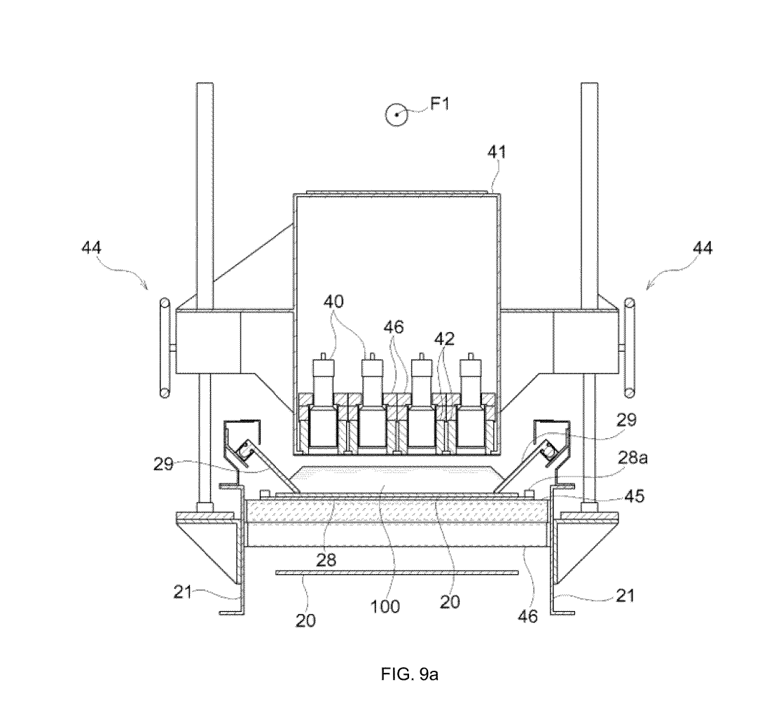

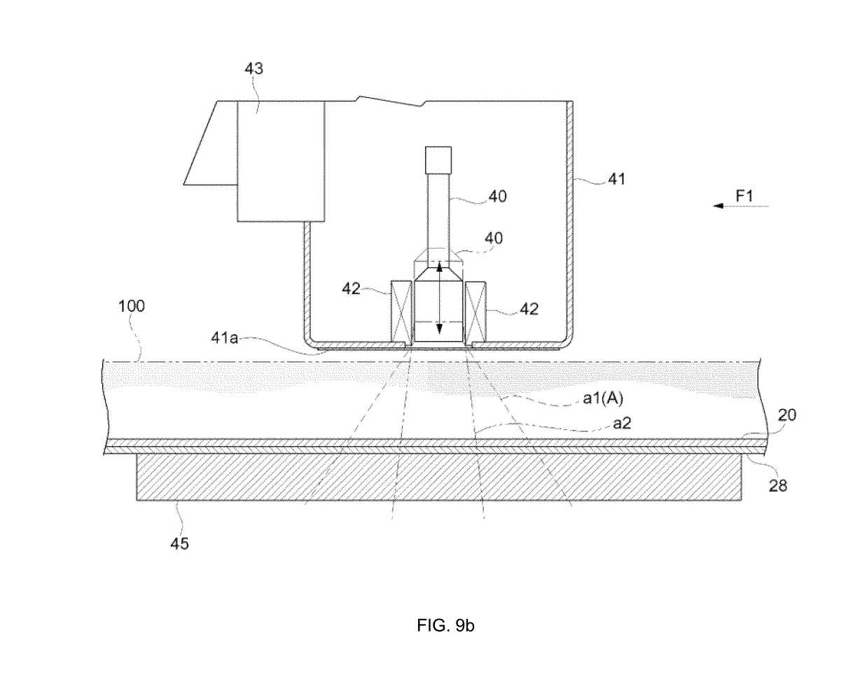

As illustrated in FIGS. 9a and b, the measuring apparatus 4, in outline, has a box 41 in which a plurality of measuring devices 40 are housed, a collimator 42 disposed surrounding the measuring devices 40, a temperature adjusting part 43 for adjusting the temperature inside the box 41, and a height adjusting part 44. The measuring devices 40 are arranged, for example, four in a row across the collimator 42 along a direction orthogonal to the transportation direction F1. An energy spectrum measuring device, represented by, for example, an NaI (TI) scintillation detector, and the like, is used in the measuring device 40. The temperature adjusting part 43 keeps the temperature inside the box 41 constant in order to suppress the impact of the temperature of the measuring device 40. Furthermore, energy drift can be prevented by the combined use of the temperature compensation function of the measuring device 40, and thus readjustment time can be shortened and operating efficiency improved.

As illustrated in FIG. 9b, a plate like first shielding body 45 is provided below the main belt 20 that includes a measurement range A of the measuring device 40. The first shielding body 45 is big enough to contain the measurement range A, and is disposed above a supporting member 46. By this, it is possible to move the measuring device 40 close to, and thus measure, the target object 100. Furthermore, the effect of radiation from the ground GL can be eliminated, and thus a reduction in measuring accuracy can be prevented.

Here, while it is feasible to use a structure of a conveyor of steel plate, and the like, as the first shielding body 45, a 90 mm thick lead plate is used in the present embodiment to obtain an adequate shielding effect. However, due to the weight thereof, the first shielding body 45 is, for example, divided and then disposed as a plurality of pieces. In this case, it is advisable to provide the supporting member 46 with an additional shielding body in order to prevent a reduction in the shielding effect caused by seams. Furthermore, the strength of the structure and the shielding effect can be retained by stacking the added shielding body of the supporting member 46 on the seams of the first shielding body 45.

The collimator 42 is a cylindrical ring like member surrounding the measuring device 40. Being disposed around the periphery of the measuring device 40, the collimator is, as illustrated in FIG. 9b, thus able to adjust the measurement range A (field of vision) through the vertical movement of the measuring device 40. Therefore, the measurement volume of the transported target object 100 can be a variable. For example, when the measuring device 40 is raised as illustrated in FIG. 9b, a measurement range a1 according to the collimator 42 shrinks to a measurement range a2, and the measurement volume of the target object 100 is thus reduced.

For example, a material having a significant shielding effect, such as a tungsten alloy, lead, iron, copper, and the like, is used in the collimator 42, which thus functions as a shielding body. Therefore, the first shielding body 45, which is below the collimator 42 and the main belt 20, shields the natural radiation from the periphery of the measuring apparatus 4, and thus reduces the background of the measurement range A.

In the present embodiment, a high density tungsten alloy was used in the collimator 42 and was disposed in the vicinity of the measuring device 40, and thus a maximum shielding effect was obtained. The density of a tungsten alloy is approximately 18 g/cm³ while the density of lead is approximately 11.34 g/cm³. This density ratio correlates to the thickness of the shielding body, and thus the same shielding effect can be obtained using a tungsten alloy that is approximately 63% as thick as a collimator made of lead, allowing a plurality of the measuring devices 40 to be disposed in close proximity with one another. In the present embodiment, the measuring devices 40 are disposed in the bottom part of the box 41 at a pitch of approximately 15 cm, and are thus set in close proximity to the target object 100.

Additionally, in the present embodiment, a second cylindrical shielding body 46 is provided on the top part of the collimator 42. By this, the effect of the background from above the measuring device 40 is reduced. For example, lead 30 mm thick is used as the second shielding body 46.

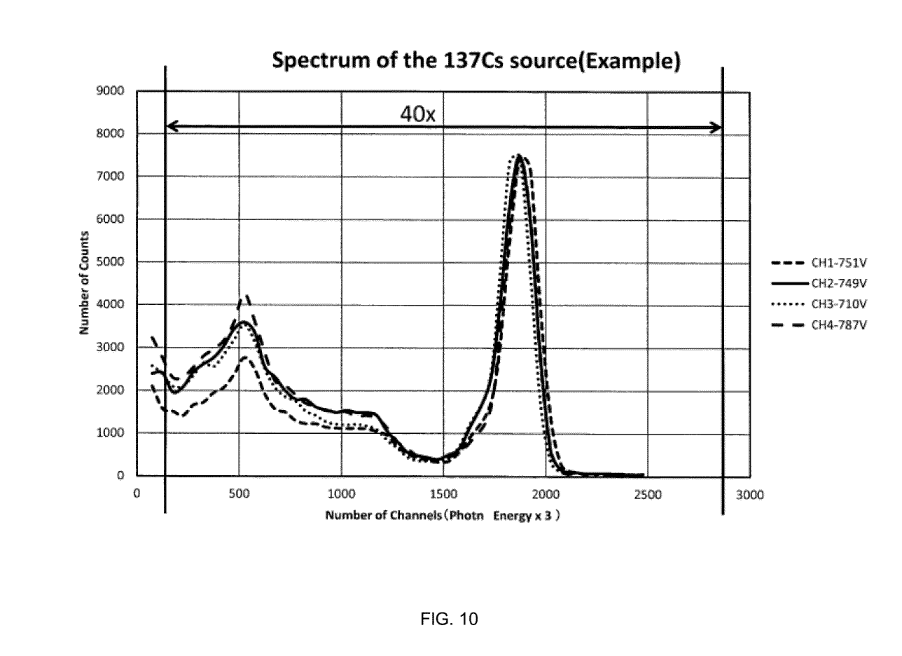

When radioactivity sorting is executed with a focus on a specific radio nuclide in the target object 100, an energy window range 40x of the measuring device 40 is set in an energy area of the specific radio nuclide. By setting an optimal energy window range 40x in relation to a photoelectric peak (emitted gamma ray energy) caused by the targeted radio nuclide, the effect of a natural nuclide contained in the target object 100 is minimized. As an example, an energy spectrum of a ¹³⁷Cs radiation source measured by an NaI (TI) scintillation detector is illustrated in FIG. 10.

The peak of ¹³⁷Cs is at 662 KeV. Thus, by making the setting 50 KeV to 950 KeV with a focus mainly on this peak portion, measurement can be done with a focus on ¹³⁷Cs and on ¹³⁴Cs as well. Because the scale of the horizontal axis is equivalent to three times the KeV units, a range of 150 to 2850 equates to the energy window range 40x. Because the energy window range 40x part is acceptable with regard to the background as well, the value of the obtained background is small. For example, uranium series and thorium series natural nuclides exhibit spectra resembling that of the aforementioned cesium, and thus energy is also distributed in a wide range. These effects can be made smaller by limiting the energy window range 40x. Additionally, potassium 40 (⁴⁰K) is present in particular abundance in the natural world, and the peak thereof is 1460 KeV. Therefore, by setting the energy window range 40x like that described above, the photoelectric peak of potassium 40 is not measured, the effect of potassium 40 is eliminated, and measuring accuracy is thus enhanced. In general, a measurement value obtained using three times the square root of the background, becomes the detection limit value. When the value of the background becomes low, the detection limit value also gets smaller.

The energy window range 40x is applied to reduce the effect of radiation caused by a natural radio nuclide present in the target object 100 or in the background, and to reduce the background. In other words, by reducing a volume, which is to be the base, the ability to detect radiation, which is to be the target to be measured, is enhanced. Furthermore, it thus becomes possible to sort based on the density of the radioactivity contained in the target object 100 without altering the nature of the object.

A vertical adjustment tool 47 is provided so that the box 41 can be changed to any height relative to the main belt 20 (target object 100). The range in which the measuring device 40 is reduced by the collimator 42 can be defined as the measurement range A using the height of the target object 100 on the main belt 20, and the dispositions of the collimator 42 and the measuring device 40.

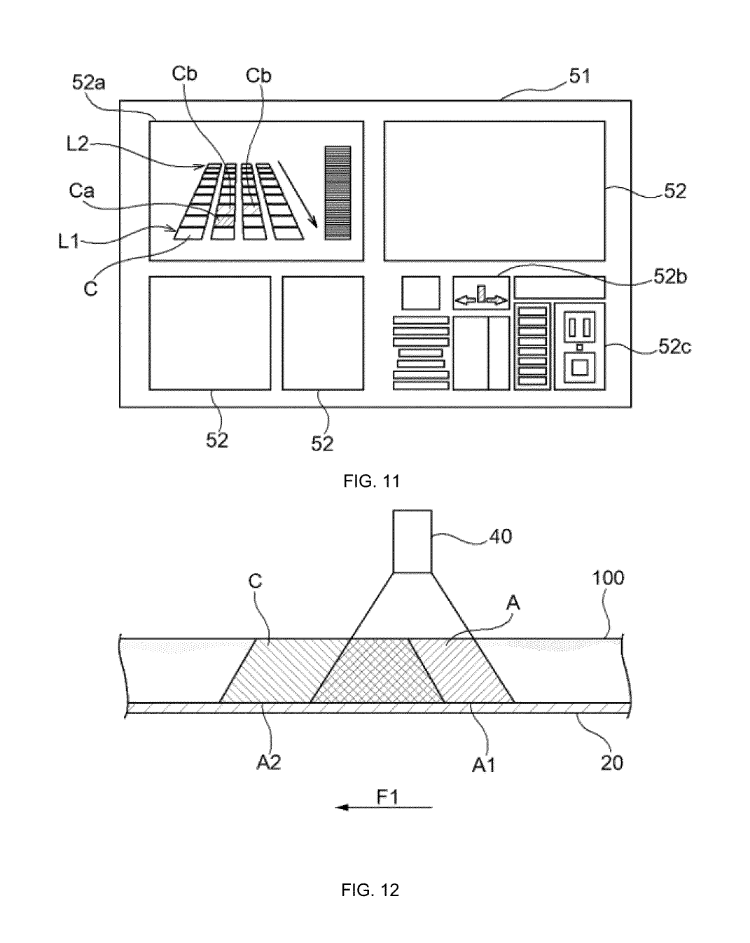

The control device 5 controls the driving of the main belt 20 and the sorting belt 30 and displays various information on a monitor 51. In the example illustrated in FIG. 11, a variety of windows 52, such as a window 52a displaying the results of the measuring devices 40, a window 52b displaying the driving direction of the sorting belt 30, and a window 52c displaying the driving status of the main belt 20, and the like, are displayed on the monitor 51.

A column C displayed in the window 52a was obtained by viewing measurement values at the measurement unit of time (for example, one second) in each of the measuring devices 40. In the example in FIG. 11, the column C differentiates levels of densities of radioactivity by color, and displays the levels so the densities of radioactivity thereof can be grasped visually. In the example in FIG. 11, the radioactivity level of a column Ca is the highest, and the level in a column Cb is the next highest. Furthermore, a top line L1 of the window 52a illustrates the position of the measuring device 40, and a line L2 farthest to the back illustrates a position just before drop off on the sorting belt 30 at the downstream end 20a of the main belt 20.

By the way, the target object 100 on the main belt 20 passes under the measuring device 40 at a fixed speed. As illustrated in FIG. 12, the measurement range A1 of the target object 100 at a start time of a measurement unit of time is moved to a location illustrated by the symbol A2 after the unit of time has passed. That is, the column C is the measurement value in the volume of the target object 100 that has passed the measurement range A during a specific unit of time. Additionally, because the target object 100 is transported at a specific speed, the measurement area of the next column C overlaps the measurement area of the previous column C. Therefore, the column C is the average value of the measurement values in the measurement unit of time, and the next column C can be regarded as the moving averaged value. Using these values, the measuring apparatus 4 converts the measurement result into a density of radioactivity and the control device 5 displays the result on the monitor 51 in real time and also determines a change in the measurement result. Here, a change in the measurement result either means that a measurement result (measurement value) that had fallen below the reference value has now exceeded the reference value, or the reverse. The control unit 5 controls the operation (driving) of the main belt 20 and the sorting belt 30 based on the change in the measurement result. Note that in the present embodiment, the highest measurement value of a line is determined by the line unit of the measuring device 40.

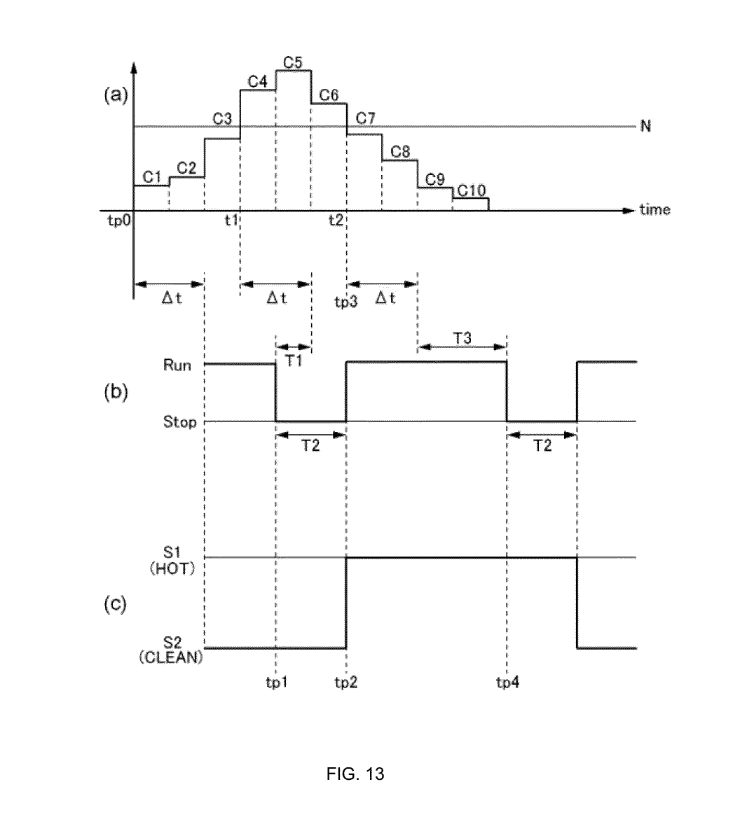

The control device 5 stores the measurement values of the measuring device 40 in chronological order. For example, as illustrated in FIG. 13, the measurement results from the past 10 columns (C1 through C10) up to the current measurement time (time) are kept. In this example, columns C4 through C6 are larger than a reference value N, and the target object 100 for this portion is sorted to the sorting area S1. In FIG. 13, the symbol Δt indicates the movement time from directly under the measuring device 40 (measurement range A) to the downstream end 20a of the main belt 20.

As has been described above, the measurement value of the column C is the average value in the measurement unit of time, and thus, for example, when a portion is present that is locally highly radioactive, there is a possibility that a variation in the result will be generated by the measurement timing due to the position of that portion. Thus, when the measurement value exceeds the reference value N, the main belt 20 is stopped at a time that is a specific first stopping time before an arrival time at which the portion will arrive at the downstream end 20a. In the example in FIG. 13, when a measurement start time is set as tp0, the main belt 20 stops at a time (arrival time tp1−first stopping time T1) that is just the first stopping time T1 earlier than the arrival time tp1 (measurement start time tp0+measurement time t1+movement time Δt) when the portion of the target object 100 of the column C4 will arrive at the downstream end 20a. In the present embodiment, the first stopping time T1 is set at one second, which is the same as the measurement unit of time, and thus corresponds to one column. By this, the portion will not drop onto the sorting belt 30, and thus will not be mixed in with a normal portion (column C3). Therefore, sorting can be done with high accuracy. Furthermore, when the measurement value exceeds the reference value N and thus the measurement result changes, because the column C is the moving averaged value, it is unlikely that a highly radioactive portion will be mixed into the sorting area S2, even if stopping is done just before the measurement value rises. Therefore, efficiency can be raised without reducing sorting accuracy.

After that, the control device 5 rotates the sorting belt 30 in reverse to a time tp2 that is after a sorting belt drive time T2 from time tp1 has elapsed, and also releases the stopping of the main belt 20. The time T2 is the time required to discharge all of the target object 100 on the sorting belt 30, and is determined based on the distance between the pulleys 32a and the drive speed of the sorting belt 30. By this, the target object 100 having different results will not be mixed in on the sorting belt 30. In the example in FIG. 13, the target object 100 corresponding to the column C4 was made to wait until the target object 100 corresponding to the column C3 on the sorting belt 30 was discharged to the sorting area S2.

After that, when the measurement value falls below the reference value N, the main belt 20 is stopped at a time that is a specific second stopping time after an arrival time at which the portion will arrive at the downstream end 20a. In the example in FIG. 13, the main belt 20 is stopped after a time (arrival time tp3+second stopping time) that is just the second stopping time T3 later than the arrival time tp3 (measurement start time tp0+measurement time t2+movement time Δt) when the portion of the target object 100 of the column C7 will arrive at the downstream end 20a. In the present embodiment, the second stopping time T1 is three seconds, which is longer than the first stopping time T1, and thus corresponds to three columns worth of time. Just as with the previous case, there are variations due to the measurement unit of time in this case as well. Furthermore, when the value falls below the reference value N, the columns C until just before this indicate a target object with radioactivity that is higher than the reference value N. Because the measurement results of the columns C is a moving average, there is a possibility that portions with high radioactivity are included in the columns C that fall below the reference value N. Therefore, if the stopping time is set the same as for cases where the reference value N is exceeded, there is a risk that portions with high levels of radioactivity will become mixed into the sorting area S2. Accordingly, sorting accuracy can be prevented from declining by setting a time that is longer than the first stopping time T1. Furthermore, all of the target object with high radioactivity on the sorting belt 30 is discharged to the sorting area S1 in the period from the time tp4 after the second stopping time T3 until the sorting belt drive time T2 has elapsed. By repeating the operation described above, highly accurate and efficient sorting can be performed in a continuous fashion based on radioactivity levels. Note that when the measurement result changes within a period of time that is shorter than the second stopping time T3, the operation can be continued without changing the driving of the main belt 20 or the sorting belt 30.

Note that daily inspections adjust equipment based on measurement values measured during the transport of a check source of known radioactivity using the main belt 20. With regard to the measurement value, a comparison to a set value is performed, in view of statistical fluctuations, with a 95% degree of reliability, and taking the 5% portion into consideration, then the sorting is executed based on radioactivity.

Finally, the possibilities of other embodiments will be mentioned. While the aforementioned embodiment described an example using cesium, the embodiment is not intended to be limited thereto. It is physically possible to continuously sort the target object 100 using measurement values of the densities of radioactivity of any other substance. Furthermore, four of the measuring devices 40 were disposed in one row in a direction orthogonal to the transportation direction F1. However, the number and arrangement of the measuring devices is not limited to that given in the description above.

Furthermore, in the embodiment described above, the density of the target object 100 may be corrected by the control device 5. For example, a weight scale is provided below the main belt 20 to measure weight, and the measurement value is corrected based on that weight. Furthermore, it is also possible to gauge the shape of the target object 100 in the vicinity of the discharge port 67 of the introduction hopper 6, calculate the quantity of the target object 100 based on said shape, and then correct the measurement value. Additionally, it is also possible to capture an image of the target object 100 in the vicinity of the discharge port 67 of the introduction hopper 6, and then correct the measurement value based on image processing of the captured image. By this, measuring accuracy can be further enhanced.

In the embodiment described above, the energy window range 40x was set as a comparatively wide range including the peak portion of ¹³⁷Cs (cesium), however, this range is not intended to be limited thereto. For example, by focusing only on the peak portion of ¹³⁷Cs (cesium) and thus setting the range from 500 KeV to 870 KeV, the energy window range 40x can be set in the range of 1500 to 2610. Of course, the range is not limited to ¹³⁷Cs (cesium), and thus may be suitably set based on the radio nuclide, target object to be measured, or the like, which is the object to be detected.

In the embodiment described above, sorting was executed by changing the operating direction of the sorting belt 30, however, sorting can be combined, for example, with a system using a segmenting method (a method that sets small box shaped sorting ducts on each of the lines of the measuring devices 40 and then sorts by each of the lines) so that sorting can be done in narrow ranges. Furthermore, sorting can also be done by driving the main belt intermittently to ensure measuring times in cases where low level radioactivity is to be measured.

### POSSIBILITY OF INDUSTRIAL USE

The present invention can sort large quantities of radioactively contaminated objects by the radiation levels thereof based on a wide range of radioactive contamination. Targeted radioactively contaminated objects are soil, waste products, incineration ash, fly ash, vegetation, and the like, as well as mixtures thereof, and may also apply to food products such as rice, fish, and the like. Furthermore, sorting is executed physically, and thus reuse after sorting is easy because the physical properties possessed by the target object to be measured are not changed.

### BRIEF DESCRIPTION OF THE NUMERICAL REFERENCES

1: Radiation measuring and sorting device, 2: Transporting mechanism, 3: Sorting mechanism, 4: Measuring apparatus, 5: Control device (personal computer), 6: Introduction hopper, 7: Height adjusting device, 9: Power supply device, 20: Main belt (transporting belt), 20a: Downstream end, 20b: Upstream end, 21: Chassis, 21z: Leg part, 22a: Drive (transport) pulley, 22b: Tail pulley, 22c: Snap pulley, 23: Return roller, 24: Inverter motor, 25: Meander prevention mechanism, 26: Scraper, 27: Baffle plate, 27a: Attaching member, 28: Plate like member, 28a: Backup member, 29: Skirt, 30: Sorting belt, 31: Chassis, 31a: Lower level, 31b: Middle level, 31c: Upper level, 32a: Pulley, 32b: Snap pulley, 32c: Drive pulley, 34: Inverter motor, 36: Scraper, 37: Trough roller, 38: Carrier roller, 38a: Securing member, 39: Skirt, 40: Measuring device, 40x: Energy window range, 41: Box, 41a: Cover, 42: Collimator, 43: Temperature adjusting part, 44: Height adjusting part, 45: First shielding body, 46: Second shielding body, 51: Monitor, 52: Window, 52a: Result window, 52b: Drive direction window, 52c: Operation control window, 60: Main body part, 60a: Upper front wall, 60b: Upper rear wall, 60c: Upper side wall, 60d: Lower front wall, 60e: Lower rear wall, 60f: Lower side wall, 61: Introduction port, 62: Height direction middle part, 63: Lower part, 64: Fixture, 65: Skirt, 66: Inclined plate, 67: Discharge port, 68: Height adjusting mechanism, 68a: Jack, 68b: End part (leverage point), 68c: Operating handle, 68d: Mounting shaft (fulcrum), 68e: Fixed base, 70: Adjusting bar, 70a: Apex part, 71: Securing part, 72: Scraper, 72a: End part, 73: Height adjusting part, 100: Target object, 100a: Top surface, 101: Uneven part, θ: Trough angle, A, A1, and A2: Ranges of measurement, C: Column, F1: Transportation direction (operating direction), F2: Operating direction, GL: Ground, H: Height, L1, and L2: Lines, S1: Sorting area (HOT side), S2: Sorting area (CLEAN side), T1: First stopping time, T2: Sorting belt drive time, T3: Second stopping time, W1: Belt width, and N: Reference value.

1. A radiation measuring and sorting device, comprising:
a transporting mechanism for transporting an introduced target object in a fixed transportation direction;
a measuring device for measuring the radiation of the target object being transported by the transporting mechanism;
a sorting mechanism for sorting the target object disposed at a downstream end of the transporting mechanism based on the measurement result of the measuring device; and
a control unit for controlling the operation of a transporting belt of the transporting mechanism and a sorting belt of the sorting mechanism;
wherein the sorting mechanism is disposed so that an operating direction of the sorting belt intersects an operating direction of the transporting belt and is capable of forward and reverse rotation, and, when the measurement result changes, the control unit stops the transporting belt after a specific time period has passed, discharges the target object on the sorting belt to the outside, releases the stopping of the transporting belt, and causes the sorting belt to rotate in reverse.

2. The radiation measuring and sorting device according to claim 1, wherein, when the measurement result exceeds a reference value, the control unit stops the transporting belt for a time that is a first stopping time before an arrival time at which a portion of the target object corresponding to the measurement result will arrive at the downstream end of the transporting belt.

3. The radiation measuring and sorting device according to claim 2, wherein, when the measurement result falls below a reference value, the control unit stops the transporting belt for a time that is a second stopping time after an arrival time at which a portion of the target object corresponding to the measurement result will arrive at the downstream end of the transporting belt.

4. The radiation measuring and sorting device according to claim 3, wherein the first stopping time is at least equal to a measurement unit of time of the measuring device, and the second stopping time is longer than the first stopping time.

5. The radiation measuring and sorting device according to claim 1, wherein the measuring device has a collimator for limiting a field of vision of the measuring device based on the height of the transporting belt that limits an energy window of the measuring device to match a specific radio nuclide in the target object.

6. The radiation measuring and sorting device according to claim 5, wherein a shielding body for blocking external radiation below the transporting belt is provided in the field of vision.

7. The radiation measuring and sorting device according to claim 6, wherein a second shielding body for blocking external radiation is provided above the collimator.

8. The radiation measuring and sorting device according to claim 1, further comprising:
a hopper for introducing the target object upstream of the measuring device;
wherein adjusting means for adjusting the thickness of the target object is provided on the hopper side between the hopper and the measuring device.

9. The radiation measuring and sorting device according to claim 1, wherein the target object is a radioactively contaminated object containing at least soil, a waste product, incineration ash, fly ash, or vegetation.

10. A radiation measuring and sorting method, comprising:
transporting an introduced target object using a transporting mechanism in a fixed transportation direction;
measuring the radiation of the target object being transported by the transporting mechanism; and
sorting the target object disposed downstream of the transporting mechanism based on the measurement result of the measuring device;
wherein the sorting mechanism is disposed so that an operating direction of a sorting belt of the sorting mechanism intersects an operating direction of a transporting belt of the transporting mechanism and is capable of forward and reverse rotation, and, when the measurement result changes, the transporting belt is stopped after a specific time period has passed, the target object on the sorting belt is discharged to the outside, the stopping of the transporting belt is released, and the sorting belt is caused to rotate in reverse.

11. The radiation measuring and sorting method according to claim 10, wherein, when the measurement result exceeds a reference value, the transporting belt is stopped for a time that is a first stopping time before an arrival time at which a portion of the target object corresponding to the measurement result will arrive at the downstream end of the transporting belt.

12. The radiation measuring and sorting method according to claim 11, wherein, when the measurement result falls below a reference value, the transporting belt is stopped for a time that is a second stopping time after an arrival time at which a portion of the target object corresponding to the measurement result will arrive at the downstream end of the transporting belt.

13. The radiation measuring and sorting method according to claim 12, wherein the first stopping time is at least equal to a measurement unit of time of the measuring device, and the second stopping time is longer than the first stopping time.
